(19) United States
(12) Patent Application Publication
(10) Pub. No.: US 2013/0242263 A1
(43) Pub. Date: Sep. 19, 2013

(54) CINEMA STRUCTURE AND A METHOD FOR FACILITATING PROJECTING AND VIEWING A MOTION PICTURE

(71) Applicant: Thomas Anderson, Dublin (IE)

(72) Inventor: Thomas Anderson, Dublin (IE)

(73) Assignee: IMAGE LIMITED, Douglas (IM)

(21) Appl. No.: 13/810,053

(22) PCT Filed: Jul. 15, 2011
(86) PCT No.: PCT/IE11/00037

§ 371 Date: May 29, 2013

(30) Foreign Application Priority Data
Jul. 15, 2010 (IE) S2010/0438

(51) Int. Cl. E04H 3/22; G03B 21/00

(52) U.S. Cl. CPC E04H 3/22; G03B 21/00
USPC 352/38; 52/8

(57) ABSTRACT

A cinema structure (1) comprises an auditorium (3) having a flat planar screen (10) onto which images of a motion picture is projected by a projector (12) located adjacent a rear wall (5) of the auditorium (3). Seating (14) comprising rows (15) of seats (16) are supported on tiered plinths (18) which are tiered at an angle α of approximately 25°. A front row (15a) of the seats (16) is formed in two parts, namely, a left-hand part (44a) and a right-hand part (44b) on a front plinth (18a), which is also formed in two parts, namely, a left-hand part (42a) and a right-hand part (42b). The left and right-hand parts of the front row (15a) and the front plinth (18) define central gaps (45,43, respectively) in order to accommodate the projected beam of the motion picture uninterrupted from the projector (12) to the screen (10). The rows (15) of seats (16) are pitched at a horizontal pitch (P1) of 1,300 mm, and each plinth (18) is at a vertical height (h₁) of approximately 600 mm above its adjacent plinth (18). The front plinth (18a) is at a height of approximately 1,200 mm above a floor (8) of the auditorium (3). The screen (10) extends substantially the width of a front end wall (4) between opposite side walls (6) of the auditorium (3), and extends substantially the full height of the front end wall (4) between the floor (8) and the ceiling (9) of the auditorium (3).

The present invention relates to a cinema structure, and the invention also relates to a method for facilitating projecting and viewing a motion picture.

Cinemas and cinema structures comprising an auditorium within which motion pictures are projected by a projector onto a screen for viewing by patrons in the auditorium are well known. In general, a screen is located adjacent the front of the auditorium, and images of the motion picture are projected from a projector adjacent the rear of the auditorium onto the screen. Seating in the auditorium typically is tiered, and inclined in a generally upwardly direction from the screen. However, in general, patrons sitting in seats in the auditorium of cinemas known heretofore when viewing images of the motion picture on a screen do not obtain a particularly intimate experience, in that in general they do not feel part of the action of the motion picture. This is largely due to the construction of such cinemas.

There is therefore a need for a cinema structure which provides patrons in the auditorium with a more intimate experience than that which in general is provided by cinemas and cinema structures known heretofore. There is also a need for a method of projecting and viewing a motion picture which likewise provides patrons in an auditorium of a cinema structure with a more intimate experience than can be obtained in general in cinemas and cinema structures known heretofore.

The present invention is directed towards providing such a cinema structure and a method.

According to the invention there is provided a cinema structure comprising a front end wall and a rear end wall spaced apart from the front end wall and defining with the front end wall an auditorium, a screen being located adjacent the front end wall, the screen extending from a lower edge to a spaced apart upper edge and from one of a pair of spaced apart side edges to the other side edge, an image projecting means located spaced apart from the screen adapted for projecting a motion picture onto the screen, and tiered seating located in the auditorium, the tiered seating defining tiering angle of the seating in the range of 20° to 40° rising in a general direction from the front end wall to the rear end wall.

In one embodiment of the invention the tiering angle of the seating lies in the range of 22° to 30°. Preferably, the tiering angle of the seating is approximately 25°.

In another embodiment of the invention the seating comprises a plurality of seats configured in rows. Preferably, the rows of seats extend substantially transversely of the tiering. In another embodiment of the invention the rows of the seats are spaced apart at a horizontal pitch in the range of 1,000 mm to 1,500 mm. Preferably, the rows of the seats are spaced apart at a horizontal pitch of approximately 1,300 mm.

Preferably, the rows of the seats are arcuately configured when viewed in plan. Advantageously, the rows of the seats when viewed from the screen are configured to be concave.

In one embodiment of the invention a centre one of the seats in a row of the seats immediately behind a front row of the seats is spaced apart a perpendicular distance from the screen in the range of 4 metres to 8.5 metres. Preferably, the centre one of the seats in the row of the seats immediately behind the front row of the seats is spaced apart a perpendicular distance from the screen of approximately 7.3 metres.

In another embodiment of the invention a centre one of the seats in a back row of the seats is spaced apart from the screen a perpendicular distance in the range of 12 metres to 30 metres. Preferably, the centre one of the seats of the back row of the seats is spaced apart a perpendicular distance from the screen of approximately 14 metres.

In another embodiment of the invention the front row of seats comprises a left-hand part and a right-hand part spaced apart from each other and defining a central gap therebetween which is free of seats. Preferably, the central gap defined between the left-hand and right-hand parts of the front row is of length corresponding to the space which would be occupied by a number of the seats arranged side by side, the said number of seats lying in the range of three seats to nine seats. Advantageously, the said number of seats is approximately seven seats.

Preferably, the number of seats in the left-hand part of the front row of seats is similar to the number of seats in the right-hand part thereof. Advantageously, the number of seats in each of the left-hand and right-hand parts of the front row lies in the range of five seats to twenty seats. Ideally, the number of seats in each of the left and right-hand parts of the front row is nine seats.

Preferably, the left and right parts of the front row are equi-spaced on opposite sides of a vertical plane bisecting the screen between the respective side edges thereof and extending perpendicularly from the screen.

In another embodiment of the invention the rows of the seats are supported on respective plinths. Preferably, the vertical rise between adjacent plinths lies in the range of 400 mm to 800 mm. Advantageously, the vertical rise between adjacent plinths is approximately 600 mm.

In one embodiment of the invention the plinth on which the front row of the seats is supported is at a vertical level above the lower edge of the screen in the range of 1,000 mm to 1,400 m. Preferably, the plinth on which the front row of the seats is supported is at a vertical level above the lower edge of the screen of approximately 1,200 mm.

In another embodiment of the invention the plinth on which the front row of seats is supported comprises a left-hand part and a right-hand part spaced apart from each other, and defining a central gap therebetween, the seats of the left and right-hand parts of the front row being supported on the left and right-hand parts, respectfully, of the front plinth. Preferably, the length of the central gap defined by the left and right-hand parts of the front plinth is substantially similar to the length of the central gap defined by the left and right-hand parts of the front row of seats. Advantageously, the left and right-hand parts of the plinth are equi-spaced on opposite sides of the vertical plane bisecting the screen between the respective side edges thereof and extending perpendicularly from the screen.

In another embodiment of the invention a first lower row of seats is located in front of the front row of seats, the said first lower row of seats being supported at a level substantially similar to the level of the lower edge of the screen. Preferably, the first lower row of seats comprises a left-hand part and a right-hand part, the left and right-hand parts thereof being equi-spaced on opposite sides of the vertical plane bisecting the screen between the respective side edges thereof and extending perpendicularly from the screen.

In another embodiment of the invention a second lower row of one or both of seats and wheelchair spaces is located in the central gap defined by the front plinth at a level substantially similar to the level of the lower edge of the screen.

In a further embodiment of the invention a first upper row of seats is located behind the back row of seats. Preferably, the first upper row of seats comprises a left-hand part and a right-hand part equi-spaced on opposite sides of the vertical plane bisecting the screen between the respective side edges thereof and extending perpendicularly from the screen. Advantageously, the left and right-hand parts of the first upper row of seats are located on opposite sides of a projection room.

Advantageously, the first upper row of seats is supported on a rear plinth, and the vertical rise between the rear plinth supporting the first upper row of seats and the plinth supporting the back row of seats lies in the range of 400 mm to 800 mm. Preferably, the vertical rise between the rear plinth supporting the first upper row of seats and the plinth supporting the back row of seats is approximately 600 mm.

Preferably, the horizontal pitch between the back row of seats and the first upper row of seats lies in the range of 1,000 mm to 1,500 mm. Advantageously, the horizontal pitch between the back row of seats and the first upper row of seats is approximately 1,300 mm.

In one embodiment of the invention the aspect ratio of the screen is in the range of 1.85:1 to 2.35:1. Preferably, the aspect ratio of the screen is approximately 1.95:1.

In another embodiment of the invention the screen is of overall width from one side edge to the other in the range of 10 metres to 24 metres. Preferably, the screen is of overall width from one side edge to the other of approximately 16 metres. Advantageously, the height of the screen from the lower edge to the upper edge thereof lies in the range of 5 metres to 12 metres. Preferably, the height of the screen from the lower edge to the upper edge thereof is approximately 8 metres.

In one embodiment of the invention the screen extends substantially from the floor of the auditorium to the ceiling thereof. Advantageously, the screen extends from one side wall of the cinema structure to another side wall thereof, the side walls of the cinema structure being spaced apart from each other and extending from the front end wall to the rear end wall to define with the front and rear end walls the auditorium.

Preferably, the screen comprises a flat screen. Advantageously, the screen comprises a planar screen.

In another embodiment of the invention the image projecting means comprises a projection lens, and the image projecting means is located so that a central axis of the projection lens is located at a vertical height above a horizontal plane which bisects the screen between the lower edge and the upper edge thereof and extends perpendicularly therefrom, the vertical height of the central axis of the projection lens above the horizontal bisecting plane being in the range of one-eighth and one-third of the height of the screen from the lower edge to the upper edge thereof. Preferably, the vertical height of the central axis of the projection lens above the horizontal bisecting plane is approximately one-quarter of the height of the screen from the lower edge to the upper edge thereof.

Preferably, the central axis of the projection lens of the image projecting means lies in the vertical plane bisecting the screen between the side edges thereof and extending perpendicularly from the screen.

In another embodiment of the invention the projection lens of the image projecting means is spaced apart from the screen a perpendicular distance of up to 30 metres. Preferably, the projection lens of the image projecting means is spaced apart from the screen a perpendicular distance of up to 26 metres. Advantageously, the projection lens of the image projecting means is spaced apart from the screen a perpendicular distance in the order of 13 metres to 16 metres.

In a further embodiment of the invention the projection lens of the image projecting means comprises a Fresnel lens having a focal length in the range of 0.7 to 13.

Preferably, the image projecting means comprises a video projector.

The invention also provides a method for facilitating projecting and viewing a motion picture, the method comprising providing a cinema structure comprising a front end wall and a rear end wall spaced apart from the front end wall and defining with the front end wall an auditorium, locating a screen adjacent the front end wall, locating an image projecting means spaced apart from the screen adapted to project a motion picture onto the screen, providing tiered seating in the auditorium at a tiering angle in the range of 20° to 40° rising in a general direction from the front end wall to the rear end wall, and projecting images of the motion picture from the image projecting means onto the screen.

The advantages of the invention are many. A particularly important advantage of the invention is that patrons in the auditorium of the cinema structure according to the invention are provided with quite an intimate experience, in that the patrons seated in the auditorium virtually become a part of the action of the motion picture, to the extent that such patrons are provided with an experience of participating in the action of the motion picture. It has been found that this intimate experience which is provided to patrons seated in the auditorium is highly impressive, and furthermore, by virtue of the tiering of the seating and the location of the seating relative to the screen, as well as being provided with an intimate experience, patrons seated in the auditorium are provided with a clear and uninterrupted view of the entire screen. Additionally, the provision of the central gap between the left and right-hand parts of the front row and the central gap between the left and right-hand parts of the front plinth, allow the beam of images of the motion picture projected by the image projecting means uninterrupted onto the screen.

The invention will be more clearly understood from the following description of a preferred embodiment thereof, which is given by way of example only, with reference to the accompanying drawings, in which:

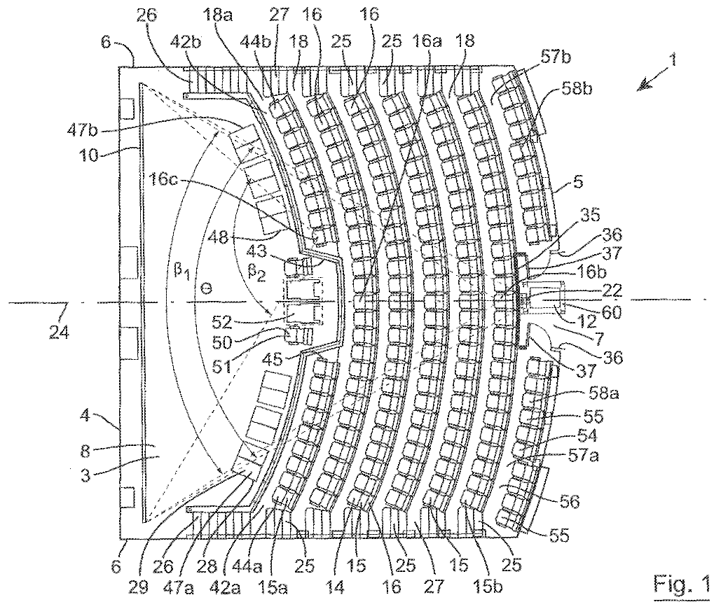

FIG. 1 is a top plan view of a cinema structure according to the invention,

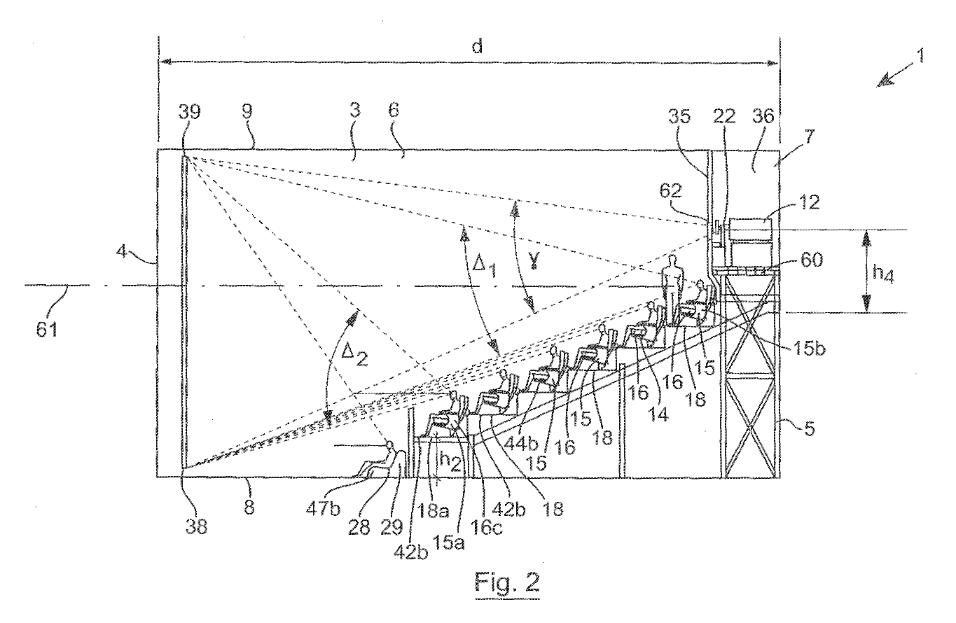

FIG. 2 is a side elevational view of the cinema structure of FIG. 1 on the line II-II of FIG. 1,

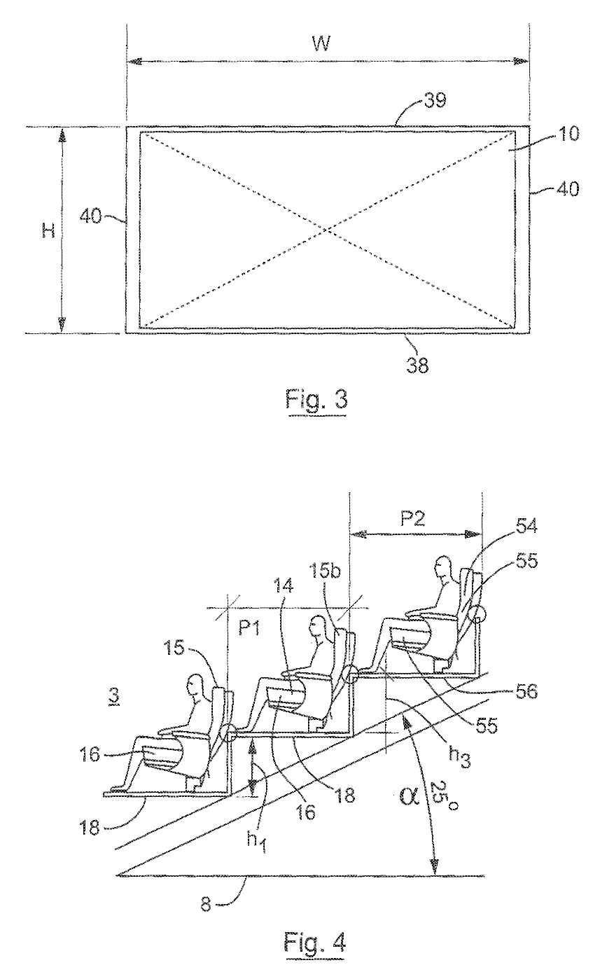

FIG. 3 is a front end elevational view of a screen of the cinema structure of FIG. 1, and

FIG. 4 is an enlarged side elevational view of a detail of the cinema structure of FIG. 1.

Referring to the drawings, there is illustrated a cinema structure according to the invention, indicated generally by the reference numeral 1, within which a motion picture is projected for viewing. The cinema 1 comprises an auditorium 3 defined between a front end wall 4 and a spaced apart rear end wall 5 and spaced apart parallel side walls 6 extending between the front and rear end walls 4 and 5. The front and rear end walls 4 and 5 and the side walls 6 extend upwardly from a floor 8 of the auditorium 3 to a ceiling 9 of the auditorium 3.

A vertically disposed flat planar screen 10 is located within the auditorium 3 adjacent to and mounted on the front end wall 4, and an image projecting means, namely, a projector 12 described briefly below projects images of the motion picture onto the screen 10. The projector 12 is located in a projection room 7 which extends from the rear end wall 5 into the auditorium 3. Front and side walls 35 and 36, respectively, partition the projection room 7 from the auditorium 3. The side walls 36 of the projection room 7 extend from the rear end wall 5 to the front wall 35 of the projection room 7. Doors 37 in the side walls 36 provide access to the projection room 7 from the auditorium 3.

The screen 10 defines spaced apart lower and upper edges 38 and 39, respectively, and spaced apart opposite side edges 40, and extends from the lower edge 38 to the upper edge 39 and from one side edge 40 to the other side edge 40. Additionally, the height H of the screen 10 is such that the screen 10 extends substantially the height of the front end wall 4 from the floor 8 to the ceiling 9 of the auditorium 3. The width W of the screen 10 between the side edges 40 is such that the screen 10 extends substantially the width of the front end wall 4 between the side walls 6 of the auditorium 3. In this embodiment of the invention the width W of the screen 10 is approximately 16 metres, and the height H of the screen 10 is approximately 8 metres, and thus has an aspect ratio of width W to height H of 1.95:1. However, it is envisaged that the width of the screen may be in the range of 10 metres to 24 metres, but preferably, would be in the range of 13 metres to 17 metres, and the height H of the screen may be in the range of 5 metres to 12 metres, but preferably, would be in the range of 6 metres to 9 metres. However, the dimensions of the screen 10 will largely be depending on the dimensions of the front end wall 4, since in general it is desirable that the area of the screen 10 should be substantially similar to the area of the front end wall 4.

Tiered seating 14 is provided in the auditorium 3, and the tiering angle α of the seating 14 in this embodiment of the invention is approximately 25° with reference to the floor 8 of the auditorium 3. The seating 14 is arranged in rows 15 of seats 16 from a front row 15a to a back row 15b. Each row 15 of seats 16 with the exception of the front row 15a comprises twenty-five seats 16. Each row 15 of seats 16 is supported on a corresponding plinth 18. The rows 15 of seats 16 extend in a general direction from one side wall 6 to the other side wall 6 of the auditorium 3, and transversely of the direction of tiering. The rows 15 of seats 16 are configured to form an arc when viewed in plan. Each arcuate row 15 is concave when viewed from the screen 10.

The centre seat 16a of the second row 15c, which is the row 15 immediately behind the front row 15a, is spaced apart a perpendicular distance from the screen 10 of approximately 7.3 metres. The centre seat 16b of the back row 15b is spaced apart a perpendicular distance from the screen 10 of approximately 14 metres. The rows 15 of seats 16 are spaced apart from each other with a horizontal pitch P1 of approximately 1,300 mm. The vertical height h₁ of each plinth 18 above the adjacent forward plinth 18 is approximately 600 mm, thus producing the tiering angle α of approximately 25°. The plinth 18 on which the front row 15a of seats 16 is supported is at a vertical height h₂ of approximately 1,200 mm above the floor 8 of the auditorium 3, and in turn is at a vertical height also of approximately 1,200 mm above the lower edge 38 of the screen 10.

The front plinth 18a on which the front row 15a of seats 16 is supported is formed in two parts, namely, a left-hand part 42a and a right-hand part 42b. A central portion of the front plinth 18a is omitted between the left and right-hand parts 42a and 42b, so that the left and right-hand parts 42a and 42b of the front plinth 18a define a central gap 43 therebetween. The front row 15a of seats 16 is similarly formed in two parts, namely, a left-hand part 44a and a right-hand part 44b. The left-hand part 44a of the front row 15a of seats 16 is supported on the left-hand part 42a of the front plinth 18a, while the right-hand part 44b of the front row 15a of seats 16 is supported on the right-hand part 42b of the front plinth 18a. Thus, the left and right-hand parts 44a and 44b of the front row 15a define a central gap 45 above the central gap 43 defined by the left and right-hand parts 42a and 42b of the front plinth 18a. The central gaps 43 and 45 in the front plinth 18a and the front row 15a uninterruptedly accommodate a lower central portion of the projected beam of images of the motion picture from the projector 12 to the screen 10.

The left and right-hand parts 44a and 44b of the front row 15a and the left and right-hand parts 42a and 42b of the front plinth 18a are equi-spaced on opposite sides of a vertical plane 24 which bisects the screen 10 between the side edges 40 thereof and extends perpendicularly from the screen 10. The left and right-hand parts 44a and 44b each contain nine seats. The lengths of the central gaps 43 and 45 defined between the left and right-hand parts 42a and 42b and 44a and 44b of the front plinth 18a and the front row 15a, respectively, are substantially similar to each other, and are substantially similar to the space which would be occupied by seven seats arranged side by side relative to each other.

Side aisles 27 located on each side of the auditorium 3 between the ends of the rows 15 of seats 16 and the adjacent one of the side walls 6 provide access to the rows 15 of seats 16. Steps 25 are provided in the side aisles 27 between adjacent plinths 18, and due to the tiering angle of the rows 15 of seats 16, and the vertical height h₁ between adjacent plinths 18, three steps 25 of similar height are provided from one plinth 18 to the next adjacent plinth 18 in each side aisle 27. Seven steps 26 are provided in each side aisle 27 between the floor 8 of the auditorium 3 and the front plinth 18a.

A first lower row 28 of seats 29 is provided on the floor 8 of the auditorium 3 in two parts, namely, a left-hand part 47a and a right-hand part 47b. The first lower row 28 of seats 29 is located in front of and adjacent the front plinth 18a, and is arcuate when viewed in plan and concave when viewed from the screen 10. The left and right-hand parts 47a and 47b of the first lower row 28 of seats 29 each comprise six seats, and define a central gap 48 which is of greater length than the length of the central gaps 43 and 45 to uninterruptedly accommodate the lower central portion of the projected beam of images of the motion picture from the projector 12 to the screen 10. The left and right-hand parts 47a and 47b of the first lower row 28 are equi-spaced on opposite sides of the vertical bisecting plane 24, which extends perpendicularly from the screen 10.

A second lower row 50 of two seats 51 and two adjacent wheelchair spaces 52 are centrally located on the floor 8 of the auditorium 3 in the central gap 43 defined between the left-hand and right-hand parts 42a and 42b of the front plinth 18a. The location of the second lower row 50 of the seats 51 and wheelchair spaces 52 on the floor 8 and in the central gap 43 is such that neither the seats 51 nor wheelchairs in the wheelchair spaces 52 nor patrons occupying the two seats 51 and wheelchair spaces 52 interrupt the projected beam of images of the motion picture from the projector 12 to the screen 10.

A first upper row 54 of seats 55 is located behind the back row 15b of seats 16 on a rear plinth 56. The seats 55 of the first upper row 58 are similar to the seats 16 of the rows 15. The first upper row 54 of seats 55 is arcuate when viewed in plan, and is concave when viewed from the screen 10. The rear plinth 56 is formed in two parts, namely, a left-hand part 57a and a right-hand part 57b, which extend respectively from the projection room 7 on opposite sides thereof to the corresponding side wall 6 of the auditorium 3. Similarly, the first upper row 54 of seats 55 is formed in two parts, namely, a left-hand part 58a and a right-hand part 58b, and the seats 55 of the left and right-hand parts 58a and 58b are supported on the left-hand and right-hand parts 57a and 57b, respectively, of the rear plinth 56. The left and right-hand parts of the first upper row 54 each comprise ten seats 55.

The vertical height h₃ of the rear plinth 56 above the plinth 18 on which the back row 15b of seats 16 is supported is approximately 600 mm. The horizontal pitch P2 between the back row 15b of seats 16 and the first upper row 54 of seats 55 is approximately 1,300 mm. The first four seats 55 adjacent each outer end of the first upper row 54 are spaced back from seats 16 of the back row 15b a distance greater than the spacing between the remaining seats 55 of the first upper row 54 and the seats 16 of the back row 15b in order to provide more legroom and additional comfort for patrons.

The configuration of the rows 15 of seats 16 is such that a patron sitting in the central seat 16b of the back row 15b of seats 16 has a horizontal viewing angle β₁ of approximately 65° of the screen 10 from one side edge 40 of the screen 10 to the other side edge 40 thereof. The patron sitting in the central seat 16b of the back row 15a has a vertical viewing angle Δ₁ of approximately 35° of the screen 10 from the lower edge 38 to the upper edge 39 of the screen 10. A patron sitting in one of the two innermost seats 16c in the front row 15a has a horizontal viewing angle β₂ of the screen 10 of approximately 100° between the side edges 40 of the screen 10. The patron sitting in one of the two innermost seats 16c of the front row 15a is provided with a vertical viewing angle Δ₂ of approximately 60°.

Turning now to the projector 12, an opening 62 in the front wall 35 of the projection room 7 accommodates the beam of images of the motion picture from the projector 12 to the screen 10. The projector 12 is a DCI compliant digital projector, and comprises a projection lens 22, which in this embodiment of the invention is a Fresnel lens with a focal length in the range of 0.7 to 1.3. The projector 12 is located in the projection room 7 and supported on a support 60 so that a central axis of the projection lens 22 is contained in the vertical plane 24 which bisects the screen 10 between the side edges 40 thereof and extends perpendicularly from the screen 10. The projector 12 is supported on the support 60 within the projection room 7 at a level such that the central axis of the projection lens 22 of the projector 12 is at a height h₄ above a horizontal plane 61 which bisects the screen 10 between the lower edge 38 and the upper edge 39 thereof and extends perpendicularly from the screen 10. The height h₄ in this embodiment of the invention is approximately one quarter of the height H of the screen 10, see FIG. 2. The projector 12 is mounted on the support 60 so that the projection lens 22 of the projector 12 is located at a perpendicular distance d from the screen 20 of between 13 metres and 14 metres. This, thus, provides a horizontal projection angle θ of approximately 60° from the projection lens 22 of the projector 12 to the respective opposite side edges 40 of the screen 10, and a vertical projection angle γ of approximately 35° from the projection lens 22 of the projector 12 to the lower and upper edges 38 and 39 of the screen 10.

In use, images of the motion picture are projected by the projector 12 onto the screen 10 so that the images of the motion picture fill the entire screen 10 across its full width W from one side edge 40 to the other side edge 40, and the full height H of the screen 10 from the lower edge 38 to the upper edge 39. Since the screen 10 extends substantially the full width of the front wall 4 of the auditorium 3 between the side walls 6, and since the screen 10 extends substantially the full height of the front wall 4 from the floor 8 to the ceiling 9 of the auditorium, and since the tiering angle of the seating 14 is approximately 25°, a patron sitting in any of the seats 16, 28, 51, 55 or in the wheelchair spaces 52 is provided with a particularly intimate experience, whereby such a patron is provided with the impression of virtually becoming a part of the action of the motion picture to the extent that such a patron is provided with the experience of participating in the action of the motion picture.

Additionally, the relatively steep tiering of the angle α of the rows 15 of seats 16 and the first upper row 54 of seats 55 provides every patron in the auditorium, including those in the first and second lower rows 28 and 50 with a full and uninterrupted view of the screen 10. This uninterrupted view of each patron in the auditorium 3 of the screen 10 is further enhanced by the horizontal pitching P1 of the rows 15 of the seats 16 and the first upper row 54 of seats 55 which also provide legroom and comfort to persons sitting therein, and in particular by the height h₁ and h₃ of the plinths 18 and 56 above the adjacent plinths 18.

The provision of the central gap 43 between the left and right-hand parts 42a and 42b of the front plinth 18a and the central gap 45 between the left and right-hand parts 44a and 44b of the front row 15a of seats 16 ensures that the beam of the images of the motion picture projected by the projector 12 onto the screen 10 is uninterrupted.

While the cinema structure has been described as comprising a first lower row 28 of seats 29 and a second lower row 50 of seats 51 and wheelchair spaces 52, while this is desirable, it is not essential. It is also envisaged that the first upper row 54 of seats 55 may be omitted, and in which case, the back row 15b of seats 16 would be the last row of seats in the auditorium.

While the vertical height between adjacent plinths has been described as being 600 mm, it is envisaged that the vertical height between adjacent plinths may be in the range of 400 mm to 800 mm. It is also envisaged that the horizontal pitch between the plinths 18 and between the rear plinth 56 and the plinth 18 supporting the back row 15b of seats 16 may be greater or less than 1,300 metres, and may in fact lie in the range of 1,000 mm to 1,500 mm. It is also envisaged that the tiering angle α of the seating may be of any angular value between 20° and 40°.

While the screen has been described as comprising an aspect ratio of 1.95:1, it is envisaged that the aspect ratio of the screen may be in the range of 1.85:1 to 2.35:1.

While the screen has been described as being of width 16 metres, it is envisaged that the screen may be of width in the range of 10 metres to 24 metres, but would preferably be of width in the range of 13 metres to 17 metres. Additionally, while the screen has been described as being of height of 8 metres, it is envisaged that the height of the screen may be of any suitable height in the range of 5 metres to 12 metres, but would preferably be of height in the range of 6 metres to 9 metres. However, in general, the height and width of the screen will be dictated by the area of the front end wall, since it is desirable that the screen should be of substantially similar width and height to the width and height, respectively, of the front end wall.

While the rows 15 have been described as each comprising twenty-five seats with the exception of the front row 15a, it will be appreciated that the number of seats in each row will largely be dictated by the width of the auditorium between the side walls 6. Additionally, while the left and right-hand parts of the front row 15a have been described as each comprising nine seats, it will be appreciated that the number of seats in each left and right-hand part of the front row will also be determined largely by the width of the auditorium between the side walls 6. Needless to say, it is envisaged that the central gaps 43 and 45 between the left and right-hand parts of the front plinth 18a and the front row 15a may be of any desired length, other than a length corresponding to the space occupied by seven seats arranged side by side relative to each other. Indeed, the length of the central gaps 43 and 45 will largely be selected to ensure that the beam of images of the motion picture which is projected from the projector onto the screen is projected without interruptions which could otherwise be caused by obstacles, such as seats or heads of patrons sitting on such seats which would otherwise be included in the front row.

The spacing of the central seat of the row of seats immediately behind the front row of seats from the screen 10, and the spacing of the centre seat in the back row of seats from the screen 10 may be other than those described, and will largely be dictated by the size of the auditorium between the front end wall and the rear end wall.

While the projector has been described as being a video projector, any suitable projector may be used, and where the projector is a video projector, it is envisaged that the projector may be a digital video projector.

It will also be appreciated that the height of the central axis of the projection lens above the horizontal bisecting plane 61 may be any suitable height, and typically, will be a height within the range of one-eighth of the height of the screen to one-third of the height of the screen.

1-83. (canceled)

84. A cinema structure comprising a front end wall and a rear end wall spaced apart from the front end wall and defining with the front end wall an auditorium, a screen being located adjacent the front end wall, the screen extending from a lower edge to a spaced apart upper edge and from one of a pair of spaced apart side edges to the other side edge, an image projecting means located spaced apart from the screen adapted for projecting a motion picture onto the screen, and tiered seating located in the auditorium, the tiered seating defining tiering angle of the seating in the range of 20° to 40° rising in a general direction from the front end wall to the rear end wall.

85. A cinema structure as claimed in claim 84 in which the tiering angle of the seating lies in the range of 22° to 30°, and preferably, the tiering angle of the seating is approximately 25°.

86. A cinema structure as claimed in claim 84 in which the seating comprises a plurality of seats configured in rows, and preferably, the rows of seats extend substantially transversely of the tiering, and advantageously, the rows of the seats are spaced apart at a horizontal pitch in the range of 1,000 mm to 1,500 mm, and preferably, the rows of the seats are spaced apart at a horizontal pitch of approximately 1,300 mm.

87. A cinema structure as claimed in claim 86 in which the rows of the seats are arcuately configured when viewed in plan, and preferably, the rows of the seats when viewed from the screen are configured to be concave, and advantageously, a centre one of the seats in a row of the seats immediately behind a front row of the seats is spaced apart a perpendicular distance from the screen in the range of 4 metres to 8.5 metres, and preferably, the centre one of the seats in the row of the seats immediately behind the front row of the seats is spaced apart a perpendicular distance from the screen of approximately 7.3 metres, and advantageously, a centre one of the seats in a back row of the seats is spaced apart from the screen a perpendicular distance in the range of 12 metres to 30 metres, and preferably, the centre one of the seats of the back row of the seats is spaced apart a perpendicular distance from the screen of approximately 14 metres.

88. A cinema structure as claimed in claim 86 in which the front row of seats comprises a left-hand part and a right-hand part spaced apart from each other and defining a central gap therebetween which is free of seats, and preferably, the central gap defined between the left-hand and right-hand parts of the front row is of length corresponding to the space which would be occupied by a number of the seats arranged side by side, the said number of seats lying in the range of three seats to nine seats, and advantageously, the said number of seats is approximately seven seats, and preferably, the number of seats in the left-hand part of the front row of seats is similar to the number of seats in the right-hand part thereof, and advantageously, the number of seats in each of the left and right-hand parts of the front row lies in the range of five seats to twenty seats, and preferably, the number of seats in each of the left and right-hand parts of the front row is nine seats, and advantageously, the left and right parts of the front row are equi-spaced on opposite sides of a vertical plane bisecting the screen between the respective side edges thereof and extending perpendicularly from the screen.

89. A cinema structure as claimed in claim 86 in which the rows of the seats are supported on respective plinths, and preferably, the vertical rise between adjacent plinths lies in the range of 400 mm to 800 mm, and advantageously, the vertical rise between adjacent plinths is approximately 600 mm, and preferably, the plinth on which the front row of the seats is supported is at a vertical level above the lower edge of the screen in the range of 1,000 mm to 1,400 m, and advantageously, the plinth on which the front row of the seats is supported is at a vertical level above the lower edge of the screen of approximately 1,200 mm.

90. A cinema structure as claimed in claim 89 in which the plinth on which the front row of seats is supported comprises a left-hand part and a right-hand part spaced apart from each other, and defining a central gap therebetween, the seats of the left and right-hand parts of the front row being supported on the left and right-hand parts, respectfully, of the front plinth.

91. A cinema structure as claimed in claim 90 in which the length of the central gap defined by the left and right-hand parts of the front plinth is substantially similar to the length of the central gap defined by the left and right-hand parts of the front row of seats, and preferably, the left and right-hand parts of the plinth are equi-spaced on opposite sides of the vertical plane bisecting the screen between the respective side edges thereof and extending perpendicularly from the screen, and advantageously, a first lower row of seats is located in front of the front row of seats, the said first lower row of seats being supported at a level substantially similar to the level of the lower edge of the screen, and preferably, the first lower row of seats comprises a left-hand part and a right-hand part, the left and right-hand parts thereof being equi-spaced on opposite sides of the vertical plane bisecting the screen between the respective side edges thereof and extending perpendicularly from the screen.

92. A cinema structure as claimed in claim 90 in which a second lower row of one or both of seats and wheelchair spaces is located in the central gap defined by the front plinth at a level substantially similar to the level of the lower edge of the screen.

93. A cinema structure as claimed in claim 86 in which a first upper row of seats is located behind the back row of seats, and preferably, the first upper row of seats comprises a left-hand part and a right-hand part equi-spaced on opposite sides of the vertical plane bisecting the screen between the respective side edges thereof and extending perpendicularly from the screen.

94. A cinema structure as claimed in claim 93 in which the left and right-hand parts of the first upper row of seats are located on opposite sides of a projection room, and preferably, the first upper row of seats is supported on a rear plinth, and the vertical rise between the rear plinth supporting the first upper row of seats and the plinth supporting the back row of seats lies in the range of 400 mm to 800 mm, and preferably, the vertical rise between the rear plinth supporting the first upper row of seats and the plinth supporting the back row of seats is approximately 600 mm, and advantageously, the horizontal pitch between the back row of seats and the first upper row of seats lies in the range of 1,000 mm to 1,500 mm, and preferably, the horizontal pitch between the back row of seats and the first upper row of seats is approximately 1,300 mm.

95. A cinema structure as claimed in claim 84 in which the aspect ratio of the screen is in the range of 1.85:1 to 2.35:1, and preferably, the aspect ratio of the screen is approximately 1.95:1, and advantageously, the screen is of overall width from one side edge to the other in the range of 10 metres to 24 metres, and preferably, the screen is of overall width from one side edge to the other of approximately 16 metres, and advantageously, the height of the screen from the lower edge to the upper edge thereof lies in the range of 5 metres to 12 metres, and preferably, the height of the screen from the lower edge to the upper edge thereof is approximately 8 metres.

96. A cinema structure as claimed in claim 84 in which the screen extends substantially from the floor of the auditorium to the ceiling thereof, and preferably, the screen extends from one side wall of the cinema structure to another side wall thereof, the side walls of the cinema structure being spaced apart from each other and extending from the front end wall to the rear end wall to define with the front and rear end walls the auditorium, and preferably, the screen comprises a flat screen, and advantageously, the screen comprises a planar screen.

97. A cinema structure as claimed in claim 84 in which the image projecting means comprises a projection lens, and the image projecting means is located so that a central axis of the projection lens is located at a vertical height above a horizontal plane which bisects the screen between the lower edge and the upper edge thereof and extends perpendicularly therefrom, the vertical height of the central axis of the projection lens above the horizontal bisecting plane being in the range of one-eighth and one-third of the height of the screen from the lower edge to the upper edge thereof, and preferably, the vertical height of the central axis of the projection lens above the horizontal bisecting plane is approximately one-quarter of the height of the screen from the lower edge to the upper edge thereof, and advantageously, the central axis of the projection lens of the image projecting means lies in the vertical plane bisecting the screen between the side edges thereof and extending perpendicularly from the screen, and preferably, the projection lens of the image projecting means is spaced apart from the screen a perpendicular distance of up to 30 metres, and advantageously, the projection lens of the image projecting means is spaced apart from the screen a perpendicular distance of up to 26 metres, and preferably, the projection lens of the image projecting means is spaced apart from the screen a perpendicular distance in the order of 13 metres to 16 metres, and advantageously, the projection lens of the image projecting means comprises a Fresnel lens having a focal length in the range of 0.7 to 13, and preferably, the image projecting means comprises a video projector.

98. A method for facilitating projecting and viewing a motion picture, the method comprising providing a cinema structure comprising a front end wall and a rear end wall spaced apart from the front end wall and defining with the front end wall an auditorium, locating a screen adjacent the front end wall, locating an image projecting means spaced apart from the screen adapted to project a motion picture onto the screen, providing tiered seating in the auditorium at a tiering angle in the range of 20° to 40° rising in a general direction from the front end wall to the rear end wall, and projecting images of the motion picture from the image projecting means onto the screen.

99. A method for projecting and viewing a motion picture as claimed in claim 98 in which the tiering angle of the seating lies in the range of 22° to 30°, and preferably, the tiering angle of the seating is approximately 25°, and advantageously, the seating comprises a plurality of seats and the seats are configured in rows, and preferably, the rows of the seats are spaced apart at a horizontal pitch in the range of 1,000 mm to 1,500 mm, and advantageously, the rows of the seats are spaced apart at a horizontal pitch of the order of approximately 1,300 mm.

100. A method for projecting and viewing a motion picture as claimed in claim 99 in which the rows of the seats are arcuately configured when viewed in plan, and preferably, the rows of the seats when viewed from the screen are configured to be concave, and advantageously, a centre one of the seats in a row of the seats immediately behind a front row of the seats is spaced apart a perpendicular distance from the screen in the range of 4 metres to 8.5 metres, and preferably, the centre one of the seats in the row of the seats immediately behind the front row of the seats is spaced apart a perpendicular distance from the screen of approximately 7.3 metres, and advantageously, a centre one of the seats in a back row of the seats is spaced apart from the screen a perpendicular distance in the range of 12 metres to 30 metres, and preferably, the centre seat of the back row of the seats is spaced apart a perpendicular distance from the screen of approximately 14 metres.

101. A method for projecting and viewing a motion picture as claimed in claim 99 in which the front row of seats comprises a left-hand part and a right-hand part spaced apart from each other and defining a central gap therebetween which is free of seats, and preferably, the central gap defined between the left-hand and right-hand parts of the front row is of length corresponding to the space which would be occupied by a number of the seats arranged side by side, the said number of seats lying in the range of three seats to nine seats, and advantageously, the said number of seats is approximately seven seats, and preferably, the number of seats in the left-hand part of the front row of seats is similar to the number of seats in the right-hand part thereof, and advantageously, the number of seats in each part of the front row lies in the range of five seats to twenty seats, and preferably, the number of seats in each part of the front row is nine seats.

102. A method for projecting and viewing a motion picture as claimed in claim 101 in which the left and right parts of the front row are equi-spaced on opposite sides of a vertical plane bisecting the screen between the respective side edges thereof and extending perpendicularly from the screen, and preferably, the rows of the seats are supported on respective plinths, and advantageously, the vertical rise between adjacent plinths lies in the range of 400 mm to 800 mm, and preferably, the vertical rise between adjacent plinths is approximately 600 mm, and advantageously, the plinth on which the front row of the seats is supported is at a vertical level above the lower edge of the screen in the range of 1,000 mm to 1,400 m, and preferably, the plinth on which the front row of the seats is supported is at a vertical level above the lower edge of the screen of approximately 1,200 mm.

103. A method for projecting and viewing a motion picture as claimed in claim 102 in which the plinth on which the front row of seats is supported comprises a left-hand part and a right-hand part spaced apart from each other, and defining a central gap therebetween, the seats of the left and right-hand parts of the front row being supported on the left and right-hand parts, respectfully, of the front plinth, and preferably, the length of the central gap defined by the left and right-hand parts of the front plinth is substantially similar to the length of the central gap defined by the left and right-hand parts of the front row of seats, and advantageously, the left and right-hand parts of the plinth are equi-spaced on opposite sides of the vertical plane bisecting the screen between the respective side edges thereof and extending perpendicularly from the screen.
